(19) United States
(12) Patent Application Publication
(10) Pub. No.: US 2008/0062170 A1
(43) Pub. Date: Mar. 13, 2008

(54) Part identification image processor, program for generating part identification image, and recording medium storing the same

(76) Inventors: Naoyuki Satoh, Kanagawa (JP); Masaaki Kagawa, Tokyo (JP)

Correspondence Address: DICKSTEIN SHAPIRO LLP, 1825 EYE STREET NW, Washington, DC, 20006-5403, US

(21) Appl. No.: 11/896,764

(22) Filed: Sep. 5, 2007

(30) Foreign Application Priority Data
Sep. 7, 2006 (JP) 2006-242561

(51) Int. Cl. G06T 17/00

(52) U.S. Cl. 345/420

(57) ABSTRACT

A part identification image processor includes a model manager to manage a 3D model, a model region calculator, a part region calculator, an image data processor, and an image data manager. The model region calculator projects the 3D model in a direction specified by visual point information and computes model region information with an aspect ratio specified by image size information. The part region calculator projects a part constituting the 3D model in the direction and computes part region information. The image data processor cuts an entire model image and a part highlight image from the 3D model projection image according to the model region information and the part region information and computes part position information. The image data manager manages the entire model image, the part highlight image, and part position information as image data for a parts catalog.

### CROSS-REFERENCE TO RELATED APPLICATIONS

This application claims priority to Japanese Patent Application No. 2006-242561, filed Sep. 7, 2006, the disclosure of which is here by incorporated by reference in its entirety.

### FIELD OF THE INVENTION

The present invention generally relates to a part identification image processor, a program for generating a part identification image, and a recording medium storing the program.

### DISCUSSION OF THE BACKGROUND

In recent years, computer performances and technology have been advanced and various image contents are widely used. For example, an industrial product manufacturing company may create an image of an in-house product and use the image as a content of electronic media, for example, a parts catalog, a service manual, etc.

In general, an industrial product (e.g., mechanical product, an appliance, etc.) includes a plurality of component parts. It is often necessary to identify a component part in the product when viewing the image of the product.

An exploded diagram of the product may be prepared so that the component parts are identified in the image of the product. In the exploded diagram, a part identification codes may be positioned near each component part to identify the component part.

However, in the above method, it is difficult to understand a state of the product being assembled from the component parts and to identify components parts assembled around an arbitrary part.

To cope with the above problem, a method to extract a component part from a three-dimensional (3D) product model on a CAD (computer aided design) system loading information of the 3D product model has been proposed. In the method, a user may extract an arbitrary component part by specifying a closed 3D space including the component part.

### SUMMARY OF THE INVENTION

Various example embodiments disclosed herein describe a part identification image processor, a program for generating a part identification image, and a recording medium storing the program.

In one example embodiment, a part identification image processor includes a model manager configured to manage a 3D model, a model region computer, a part region computer, an image data processor, and an image data manager. The model region computer projects the 3D model in a direction specified by visual point information received via an input device to generate a projection image thereof and computes model region information, enclosing the projection image of the 3D model with an aspect ratio specified by image size information received via the input device. The part region computer projects each part of the 3D model in the direction specified by the visual point information to generate a projection image thereof and computes part region information, enclosing the projection image of the part. The image data processor cuts an entire model image according to the model region information from the projection image of the 3D model and a part highlight image of the part according to the part region information from a projection image of the 3D model in which the part is highlighted, and computes part position information specifying a location of the part highlight image in the entire model image. The image data manager manages the entire model image, the part highlight image, and part position information as image data for a parts catalog.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram illustrating a computer system configured by a program as an exemplary embodiment of a part identification image processor;

FIG. 2 is a flowchart of a computer system configured by a program as an exemplary embodiment of a part identification image processor;

FIG. 3 is a schematic diagram illustrating visual point information;

FIG. 4 is a diagram illustrating projection of apexes of a 3D model;

FIG. 5 is a flowchart of a procedure to obtain combinations of smallest X and Y coordinates and largest X and Y coordinates;

FIG. 6 is a schematic diagram illustrating part position information;

FIG. 7 is an example image data for a parts catalog; and

FIG. 8 is an example in which an image of a component part is superimposed on an image of a structure including the part.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

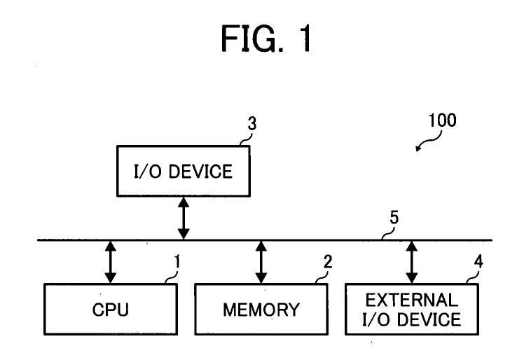

Referring now to the drawings, wherein like reference numerals designate identical or corresponding parts throughout the several views, particularly to FIG. 1, an example of a computer system configured by a program as an exemplary configuration of a part identification image processor 100 according to an embodiment of the present invention is described.

The part identification image processor 100 may include a CPU (central processing unit) 1, a memory 2, an input and output device (I/O device) 3, and an external input and output device (external I/O device) 4 that are connected via a bus 5 and exchange data with each other via the bus 5. The CPU 1 may process various data. The memory 2 may constitute a work area of the CPU 1 and store various programs, data, etc. A user may input data to and output data from the part identification image processor 100 with the input and output device 3. The part identification image processor 100 may exchange data with an external device by using the external I/O device 4.

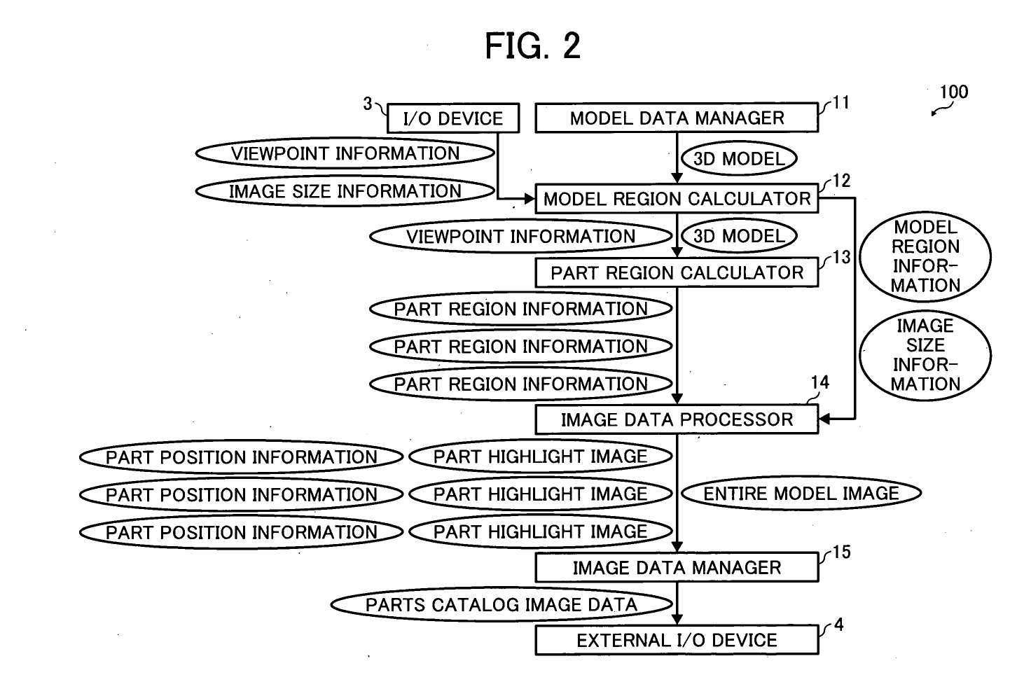

FIG. 2 illustrates an example of a computer system configured by a program as an exemplary configuration of a part identification image processor. The part identification image processor 100 may include a model data manager 11, a model region calculator 12, a part region calculator 13, an image data processor 14, and an image data manager 15.

The model data manager 11 manages data of a preliminary prepared 3D model. The model region calculator 12 receives visual point information and image size information via the I/O device 3. The model region calculator 12 projects a shape of the 3D model in a direction designated by the visual point information and computes model region information of the 3D model that encloses the projected image of the 3D model with an aspect ratio designated by the image size information.

The part region calculator 13 projects a shape of each part included in the 3D model in a direction designated by the visual point information and computes part region information enclosing the projected image of the part.

The image data processor 14 cuts an entire model image from an image in which the 3D model is projected entirely according to the model region information. The image data processor 14 cuts a part highlight image according to the part region information from a projection image of the entire 3D model in which a part constituting the 3D model is highlighted. The image data processor 14 obtains part position information specifying a location of the part highlight image in the entire model image.

The image data management part 15 manages the entire model image, the part highlight image, and part position information as image data for a parts catalog. The image data management part 15 may output the image data for the parts catalog to the external device via the external I/O device 4.

Operations of the part identification image processor 100 are described below.

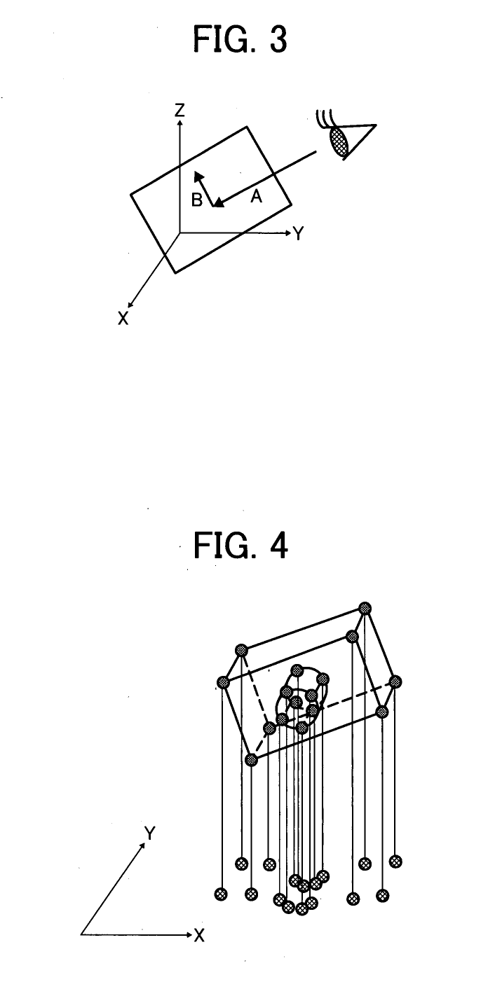

The model data manager 11 transfers the data of the preliminary prepared 3D model in which a plurality of parts are assembled to the model region calculator 12. The model region calculator 12 receives the visual point information and the image size information from the I/O device 3. As illustrated in FIG. 3, the visual point information includes a sight line vector A and a view-up vector B.

The sight line vector A is a vector to indicate a direction of a sight line in a 3D space and is used to specify a direction of a parallel projection of a 3D model. The view-up vector B is a vector to indicate an upward direction with respect to the sight line in the 3D space and is at right angle to the sight line vector A. The view-up vector B is in parallel to a projection plane of the parallel projection of the 3D model.

The image size information is specified by pixel counts in a crosswise direction (W) and a vertical direction (H).

The model region calculator 12 generates a parallel projection of the 3D model in the sight line vector received as above and obtains the model region information as a rectangular region which contains the projection of the 3D model on the projection plane. The model region calculator 12 transmits the model region information to the image data processor 14. The aspect ratio of the rectangular region is equal or similar to an aspect ratio (W/H) of the image size information. The rectangular region designates the projection plane in a X-Y rectangular coordinate system whose Y axis is in the direction of the view-up vector.

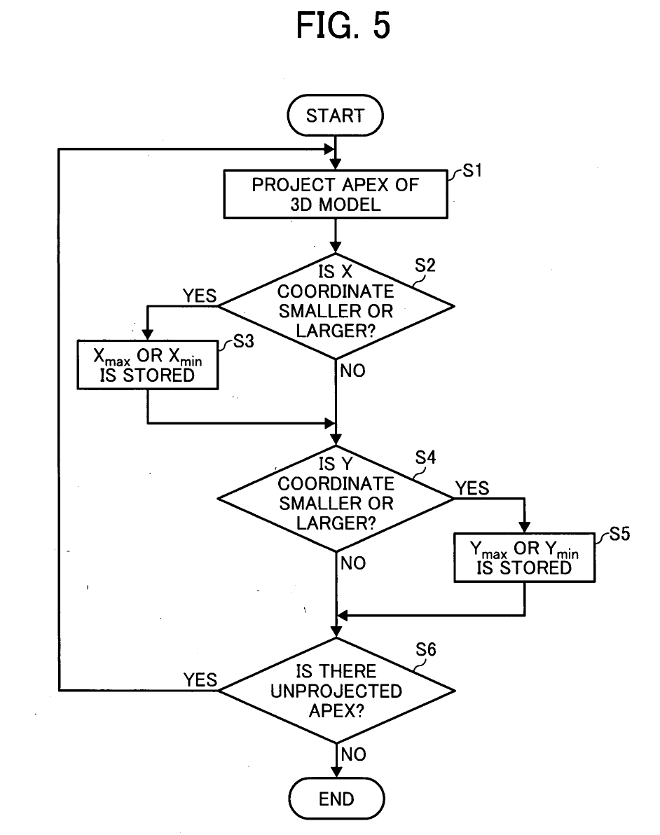

The rectangular region is evaluated as described below, referring to FIGS. 4 and 5. As illustrated in FIG. 4, all apexes defining the shape of the 3D model are projected on the projection plane. X-coordinates and Y-coordinates of the apexes are evaluated.

FIG. 5 is a flowchart of a procedure to obtain a combination of smallest X-coordinate and Y-coordinate that is referred to as (Xₘᵢₙ, Yₘᵢₙ) and a combination of largest X-coordinate and Y-coordinate that is referred to as (Xₘₐₓ, Yₘₐₓ) In FIG. 5, the model region calculator 12 projects one of the apexes defining the shape of the 3D model on the projection plane at S1.

At S2, the model region calculator 12 determines whether or not an X-coordinate of the apex is smaller or larger than an X-coordinate of any other apex projected. When the X-coordinate is smaller or larger than the X-coordinate of any other apex projected (YES at S2), the model region calculator 12 stores the X-coordinate as an Xₘᵢₙ or Xₘₐₓ at S3.

When the X-coordinate is not smaller or larger than the X-coordinate of any other apex projected (NO at S2), the model region calculator 12 determines whether or not a Y-coordinate of the apex is smaller or larger than a Y-coordinate of any other apex projected at S4. When the Y-coordinate is smaller or larger than the Y-coordinate of any other apex projected (YES at S4), the model region computer 12 stores the X-coordinate as an Yₘᵢₙ or Yₘₐₓ at S5.

At S6, the model region calculator 12 checks whether or not there is an apex that remains unprojected in the apexes of the 3D model. When there is an apex that is not projected (YES at S6), the model region calculator 12 repeats the procedure from S1. When all the apexes are projected (NO at S6), the model region calculator 12 completes the procedure.

The model region calculator 12 evaluates a smallest coordinate value (SXₘᵢₙ, SYₘᵢₙ) and a largest coordinate value (SXₘₐₓ, SYₘₐₓ) of the rectangular region as described below. The aspect ratio (W/H) of the image size is defined as α.

When Xₘₐₓ−Xₘᵢₙ>=Yₘₐₓ−Yₘᵢₙ,

SXₘᵢₙ=Xₘᵢₙ

SXₘₐₓ=Xₘₐₓ

SYₘᵢₙ=(Yₘₐₓ−Yₘᵢₙ)/2−α(Xₘₐₓ−Xₘᵢₙ)/2

SYₘₐₓ=(Yₘₐₓ−Yₘᵢₙ)/2+α(Xₘₐₓ−Xₘᵢₙ)/2.

When Xₘₐₓ−Xₘᵢₙ<Yₘₐₓ−Yₘᵢₙ,

SXₘᵢₙ=(Xₘₐₓ−Xₘᵢₙ)/2−(Yₘₐₓ−Yₘᵢₙ)/2α

SXₘₐₓ=(Xₘₐₓ−Xₘᵢₙ)/2+(Yₘₐₓ−Yₘᵢₙ)/2α

SYₘᵢₙ=Yₘᵢₙ

SYₘₐₓ=Yₘₐₓ.

The model region calculator 12 transmits the data of the 3D model and the visual point information to the part region calculator 13 and the image size information to the image data processor 14.

The part region calculator 13 generates a parallel projection of each part included in the 3D model in the direction of the sight line vector received as above and obtains the part region information as smallest rectangular regions each of which contains the projection of the part on the projection plane. The part region calculator 13 transmits the part region information to the image data processor 14.

The part region information (rectangular region) designates the projection plane in the X-Y rectangular coordinate system and is evaluated as described below.

All apexes defining a shape of each part are projected on the projection plane. X-coordinates and Y-coordinates of the apexes are evaluated. The part region calculator 13 obtains a combination of smallest X-coordinate and Y-coordinate that is referred to as (PXₘᵢₙ, PYₘᵢₙ) and a combination of largest X-coordinate and Y-coordinate that is referred to as (PXₘₐₓ, PYₘₐₓ) for each part in the 3D model. The model region calculator 13 determines the combinations of the smallest X and Y coordinates and the largest X and Y coordinates as a smallest coordinate value and a largest coordinate value of the rectangular region of the part, respectively.

The part region calculator 13 transmits the data of the 3D model and the visual point information to the image data processor 14.

The image data processor 14 generates an entire model image as follows: For example, a parallel projection image is generated by projecting the data of the 3D model in the direction of the sight line vector. The image data processor 14 cuts the parallel projection image along the model region information (rectangular region) and generates the entire model image as image data in the pixel counts according to the image size information. The image data processor 14 transmits the entire model image to the image data manager 15.

The image data processor 14 generates part highlight images as follows: For example, a parallel projection image of the 3D model in which a part is highlighted is generated for each part included in the 3D model. The image data processor 14 cuts the parallel projection image along the part region information (rectangular region) of the part. The image data generator 14 generates the part highlight image as image data in pixel counts in the crosswise and vertical directions according to the image size information, the model region information, and the part region information. The image data generator 14 transmits the part highlight images to the image data manager 15.

The pixel count in the crosswise direction is computed by

(PXₘₐₓ−PXₘᵢₙ)/((SXₘₐₓ−SXₘᵢₙ)/W),

wherein W is the pixel count in the crosswise direction.

The pixel count in the vertical direction is computed by

(PYₘₐₓ−PYₘᵢₙ)/((SYₘₐₓ−SYₘᵢₙ)/H),

wherein H is the pixel count in the vertical direction.

The image data processor 14 determines a position of the image data of the each part in the entire model image. The image data processor 14 transmits the position as part position information to the image data manager 15.

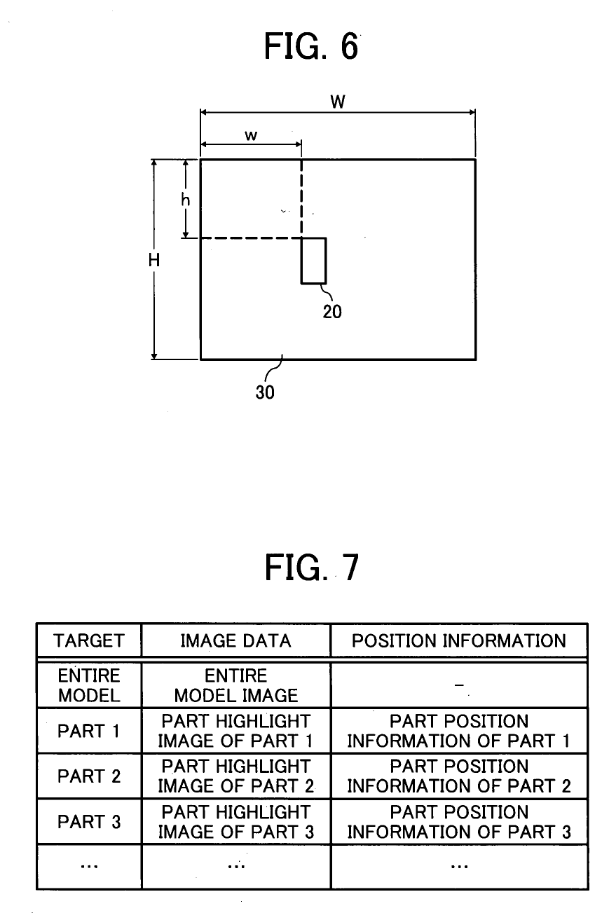

The part position information is described, referring to FIG. 6. As illustrated in FIG. 6, the part position information designates a position of an upper left apex of a part highlight image 20 with a pixel count w in the crosswise direction and a pixel count h in the vertical direction in an coordinate system whose origin is an upper left apex of a pixel region of an entire model image 30.

The pixel count w of each part is evaluated by

w=W(PXₘᵢₙ−SXₘᵢₙ)/SXₘₐₓ−SXₘᵢₙ,

wherein W is the pixel count in the crosswise direction.

The pixel count h of each part is evaluated by

h=H(SYₘᵢₙ−PYₘᵢₙ)/SYₘₐₓ−SYₘᵢₙ,

wherein H is the pixel count in the vertical direction.

The image data manager 15 compiles the entire model image, part highlight images, and part position information, for example, into a view format data structure illustrated in FIG. 7 as the image data for the parts catalog and outputs the image data to the external I/O device 4. The image data manager 15 stores and manages the image data for the parts catalog.

Therefore, the image of an arbitrary part in the 3D model may be superimposed on the image data of the entire model according to the position information of the part.

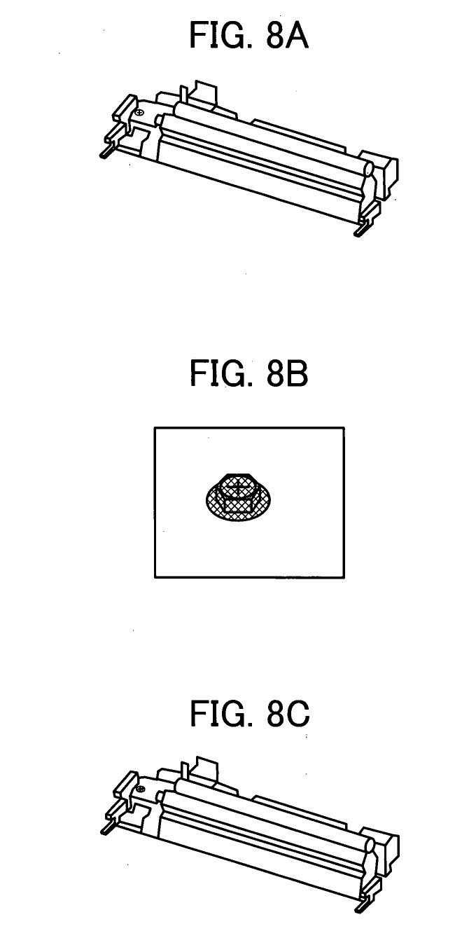

FIG. 8A is an illustration of an entire model image of a structure including a plurality of component parts. FIG. 8B is a part highlight image of a component part of the structure. The component part is highlighted in a darker color (e.g., red) than a color of the entire model image. FIG. 8C is an example in which the part highlight image is superimposed on the entire model image.

As described above, an arbitrary component of a product is recognizable in an entire model in which components thereof are assembled. Further, the arbitrary component may be identified in the entire model by a specified image size.

The arbitrary component may be identified by superimposing a part highlight image thereof on the entire model based on the part position information thereof. Further, an external I/O device may require less capacity to store the images to identify respective component parts compared with a case in which images of the respective component parts are stored in an image size equal or similar to an image size of the entire model image.

Further, the arbitrary component may be identified with a two-dimensional image thereof in the entire model image. A workload required to identify the arbitrary component by the two-dimensional image may be lighter than a case in which the component is identified by the 3D model. Therefore, a data processor or computer having a lower performance is workable.

In an embodiment, a program may include instructions to configure a computer system as a part identification image processor 100. The program may be stored in a computer-readable recording medium, which may or may not be removable.

Numerous additional modifications and variations are possible in light of the above teachings. It is therefore to be understood that within the scope of the appended claims, the disclosure of this patent specification may be practiced otherwise than as specifically described herein.

What is claimed is:

1. A part identification image processor, comprising:
a model manager configured to manage data of a prepared 3D model;
a model region calculator configured to project the 3D model in a direction specified by visual point information received via an input device to generate an projection image thereof and to compute a model region information, enclosing the projection image of the 3D model with an aspect ratio specified by image size information received via the input device;
a part region calculator configured to project each part constituting the 3D model in the direction specified by the visual point information to generate a projection image thereof and to compute part region information, enclosing the projection image of the part;
an image data processor configured to cut an entire model image according to the model region information from the projection image of the 3D model, to cut a part highlight image according to the part region information from a projection image of the 3D model in which a part is highlighted, and to compute part position information specifying a location of the part highlight image in the entire model image; and
an image data manager configured to manage the entire model image, the part highlight image, and part position information as image data for a parts catalog.

2. The part identification image processor according to claim 1,
wherein the model region calculator projects all apexes defining a shape of the 3D model on a projection plane defined by an X-Y rectangular coordinate system;
obtains a rectangular region defined by a smallest X coordinate, a smallest Y coordinate, a largest X coordinate, and a largest coordinate among coordinates of the apexes; and
determines the model region information by enlarging the rectangular region in an X axis direction or a Y axis direction thereof in proportion to the aspect ratio specified by image size information.

3. The part identification image processor according to claim 1,
wherein the part region calculator projects all apexes defining a shape of the part on a projection plane defined by an X-Y rectangular coordinate system;
obtains a rectangular region defined by a smallest X coordinate, a smallest Y coordinate, a largest X coordinate, and a largest coordinate among coordinates of the apexes; and
determines the rectangular region as the part region information.

4. The part identification image processor according to claim 1, wherein the image data processor cuts an image from the projection image of the 3D model based on the model region information to generate the entire model image in a pixel count according to the image size information;
generates the projection image of the 3D model in which the part is highlighted for each part constituting the 3D model and cuts the image of the part based on the part region information;
generates the part highlight image in a pixel count computed based on the model region information and the part region information; and
computes part position information specifying a position of the part highlight image in the entire model image based on the model region information and the part region information.

5. The part identification image processor according to claim 1, wherein the image data manager outputs the entire model image, the part highlight image, and the part position information in a view format data structure to an external input and output device, and stores and manages the entire model image, the part highlight image, and the part position information as image data for a parts catalog.

6. A storage medium containing a program for a computer system, which, when executed by said computer system, provides a part identification image processor comprising:
a model manager configured to manage data of a prepared 3D model;
a model region calculator configured to project the 3D model in a direction specified by visual point information received via an input device to generate an projection image thereof and to compute a model region information, enclosing the projection image of the 3D model with an aspect ratio specified by image size information received via the input device;
a part region calculator configured to project each part constituting the 3D model in the direction specified by the visual point information to generate a projection image thereof and to compute part region information, enclosing the projection image of the part;
an image data processor configured to cut an entire model image according to the model region information from the projection image of the 3D model, to cut a part highlight image according to the part region information from a projection image of the 3D model in which a part is highlighted, and to compute part position information specifying a location of the part highlight image in the entire model image; and
an image data manager configured to manage the entire model image, the part highlight image, and part position information as image data for a parts catalog.

7. The storage medium of claim 6, wherein said storage medium is a recording medium insertable into said computer system.

8. The storage medium according to claim 6,
wherein the model region calculator projects all apexes defining a shape of the 3D model on a projection plane defined by an X-Y rectangular coordinate system;
obtains a rectangular region defined by a smallest X coordinate, a smallest Y coordinate, a largest X coordinate, and a largest coordinate among coordinates of the apexes; and
determines the model region information by enlarging the rectangular region in an X axis direction or a Y axis direction thereof in proportion to the aspect ratio specified by image size information.

9. The storage medium according to claim 6,
wherein the part region calculator projects all apexes defining a shape of the part on a projection plane defined by an X-Y rectangular coordinate system;
obtains a rectangular region defined by a smallest X coordinate, a smallest Y coordinate, a largest X coordinate, and a largest coordinate among coordinates of the apexes; and
determines the rectangular region as the part region information.

10. The storage medium according to claim 6, wherein the image data processor cuts an image from the projection image of the 3D model based on the model region information to generate the entire model image in a pixel count according to the image size information;
generates the projection image of the 3D model in which the part is highlighted for each part constituting the 3D model and cuts the image of the part based on the part region information;
generates the part highlight image in a pixel count computed based on the model region information and the part region information; and
computes part position information specifying a position of the part highlight image in the entire model image based on the model region information and the part region information.

11. The storage medium according to claim 6, wherein the image data manager outputs the entire model image, the part highlight image, and the part position information in a view format data structure to an external input and output device, and stores and manages the entire model image, the part highlight image, and the part position information as image data for a parts catalog.
